(19) United States
(12) Patent Application Publication
(10) Pub. No.: US 2010/0188506 A1
(43) Pub. Date: Jul. 29, 2010

(54) SYNTHETIC WINDOW FOR LIMITED VISIBILITY VEHICLES

(75) Inventors: Michael D. Dwyer, Seminole, FL (US); Don Boutsomsi, St. Petersburg, FL (US); Ken Ngeth, St. Petersburg, FL (US)

Correspondence Address: HONEYWELL/IFL;Patent Services, 101 Columbia Road, P.O.Box 2245, Morristown, NJ, 07962-2245, US

(73) Assignee: Honeywell International Inc., Morristown, NJ (US)

(21) Appl. No.: 12/361,305

(22) Filed: Jan. 28, 2009

(51) Int. Cl. G09G 5/00

(52) U.S. Cl. 348/144; 348/E07.091

(57) ABSTRACT

Provided are methods, systems and devices for providing a synthetic window system for vehicles with limited visibility for passengers. Various embodiments include demountably affixing video display devices within one or more interior bulkheads such that all marginal edge portions of a viewing screen of the video display device are flushly surrounded by the first interior bulkhead. A video capture device provides a video signal to the video display device, the video capture device capturing a view from a vantage point located outside of the vehicle and in proximity to the video display device for viewing on the viewing screen of the video display device via the video signal.

### TECHNICAL FIELD

The subject matter described herein relates to the use of a synthetic window within a vehicle with limited or no passenger visibility outside the vehicle. The synthetic window may be beneficial for the relief of motion sickness, claustrophobia and for general aesthetic enjoyment.

### BACKGROUND

The B-2 bomber is a blended wing aircraft, also known as a flying wing or a delta wing. Some aircraft manufacturers are considering the introduction of high capacity passenger aircraft based on the flying wing design. The flying wing design has a lower take off weight than conventional wide body aircraft, with a concomitantly lower fuel burn rate. In short, the flying wing design may be a more efficient vehicle for carrying a large number of passengers over long distances. Indeed, a new airframe based on the flying wing design may carry 800 passengers over a 7,100 nautical mile range.

In a passenger airframe based on the flying wing design, all of the passengers may be seated inside the wing. Moreover, the surface of the wing may be used as flight control and lift surfaces. As a result, there may be no, or relatively few, passenger windows. If there are any passenger windows at all, those passengers seated well within the wing fuselage may still not have a view through a window. In most conventional airliners, even the very large Airbus A380F, passengers are only a few feet from a window allowing them to view the sky and the horizon. As such, passengers can readily obtain a sky up, ground down orientation to calm potential disturbances in their inner ears that may result from aircraft bank and roll maneuvers. Contrarily, visually uncorrelated maneuvers may increase the feeling of nausea and/or claustrophobia thus potentially making delta wing travel less attractive.

Hence, for vehicles with limited passenger visibility, there is need for a means to provide passengers with an external view from the vehicle for a variety of psychological, physiological and/or ergonomic reasons. The subject matter presented herein addresses at least these needs.

### SUMMARY

It should be appreciated that this Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Provided are exemplary embodiments which include a synthetic window system that comprises a first interior bulkhead integral to a vehicle where a first video display device is demountably affixed within a cavity of the first interior bulkhead such that all marginal edge portions of a viewing screen of the first video device are flushly surrounded by the first interior bulkhead, the viewing screen of the first video display device being viewable by the user. The embodiment also includes a first video capture device providing a first video signal to the first video display device where the first video capture device capturing a view from a first vantage point located outside of the vehicle and in proximity to the first video display device for viewing on the viewing screen of the first video display device via the first video signal.

Exemplary embodiments also include a viewing apparatus that comprises a means for detecting a first view from a first vantage point of a vehicle that is external to the skin of the vehicle and a means for rendering the first view to a user, the means for rendering the first view being embedded within a first interior bulkhead of the vehicle, wherein the first vantage point is located behind the means for rendering the first view.

Other apparatuses, methods, and/or systems according to embodiments will be or become apparent to one with skill in the art upon review of the following drawings and Detailed Description. It is intended that all such additional apparatus, systems and/or methods be included within this description, be within the scope of the present invention, and be protected by the accompanying claims.

### BRIEF DESCRIPTION OF THE DRAWINGS

FIG. 1 is a rendition of an exemplary delta wing airframe.

FIG. 2a is an overhead cutaway view of the upper deck of an exemplary passenger version of delta wing airframe.

FIGS. 2b and 2c are a longitudinal cross sectional view and a cross sectional view looking aft of an exemplary passenger version of delta wing airframe.

FIG. 3 are a frontal and a side view of a synthetic window in place according to embodiments described herein.

FIG. 4 is a simplified synthetic window arrangement according to embodiments described herein.

### DETAILED DESCRIPTION

The following disclosure is directed to devices and systems that provide passengers in a vehicle that has limited or no viewing opportunity with simulated views exterior to the vehicle. Such devices may be described as synthetic windows.

The subject matter now will be described more fully below with reference to the attached drawings which are illustrative of various embodiments disclosed herein. Like numbers refer to like objects throughout the following disclosure. The attached drawings have been simplified to clarify the understanding of the systems, devices and methods disclosed. The subject matter may be embodied in a variety of forms. The exemplary configurations and descriptions, infra, are provided to more fully convey the subject matter disclosed herein.

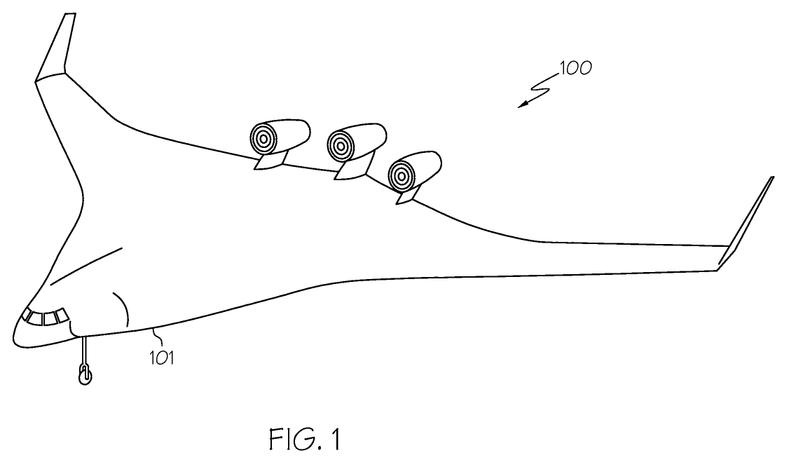

The subject matter herein will be disclosed below in the context of a large passenger aircraft utilizing a delta wing architecture that is currently embodied by the B-2 Bomber. (See, FIG. 1). However, it will be understood by those of ordinary skill in the art that the subject matter is similarly applicable to many vehicle types. Non-limiting examples of other vehicle types in which the subject matter herein below may be applied includes aircraft, spacecraft, submarines and ships. Other possible applications may include undersea and extraterrestrial habitats utilizing pressure bulkheads. Such habitats are considered to be vehicles for purposes of the disclosure herein.

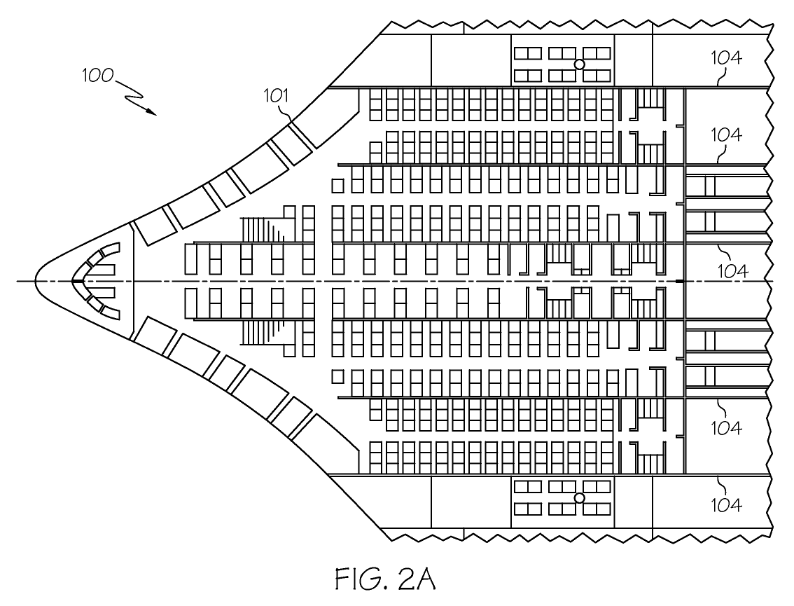

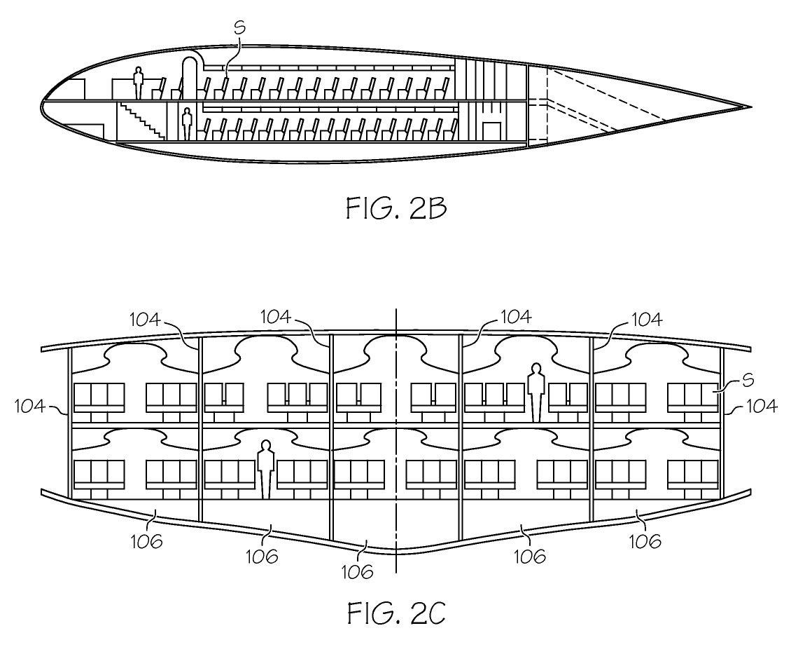

FIGS. 2a and 2b depict an exemplary passenger configuration for an aircraft 100 using a flying wing architecture. The depicted configuration includes two passenger levels with 26 columns of passenger seats 103 in each level. Because the fuselage 101 is the aerodynamic wing, the fuselage surface area available for windows is very small or non-existent. In such an enclosed space where both aerial maneuvers and turbulence is likely, high incidences of claustrophobia and motion sickness may occur among the passengers and crew.

However, in these circumstances synthetic windows may prove beneficial to the passengers and crew. Synthetic windows may be provided by creating a fuselage within the fuselage 101 using internal bulkheads 104, and inserting the synthetic windows (not shown in FIGS. 2a and 2b) within the bulkheads 104. The interior bulkheads 104 may be structural bulkheads or they may false bulkheads installed to contain a plurality of synthetic windows.

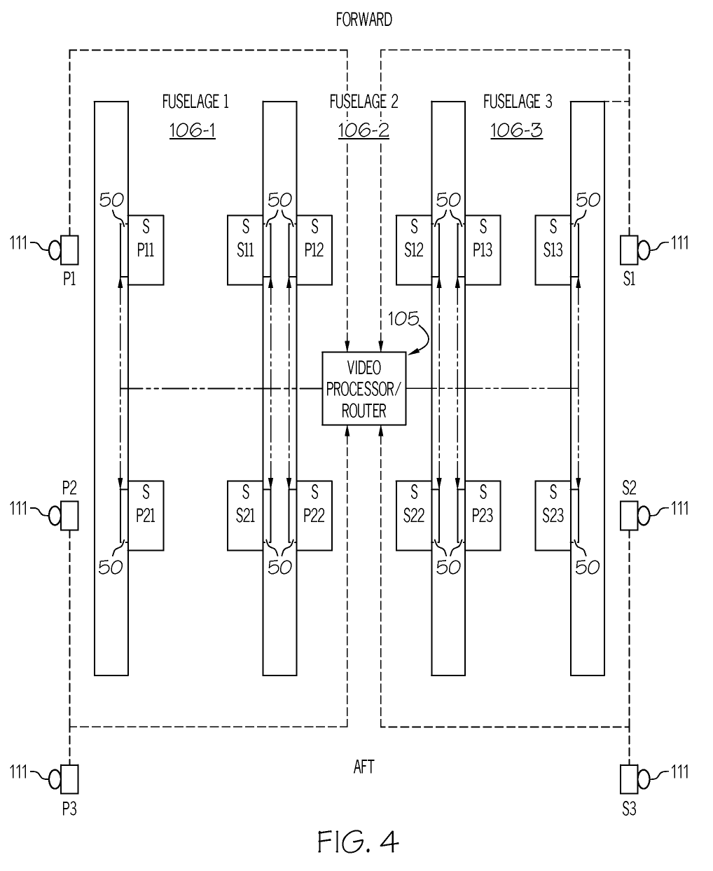

Each of the number, length and type of bulkheads 104 to be installed is a design choice. However, factors to be considered may include the number of seats in a row, the size of the synthetic windows to be installed and the number to be installed. As a non-limiting example, it may be desirable to simulate the fuselage of a smaller, conventional passenger aircraft. In FIG. 2b, the aircraft 100 includes six interior bulkheads 104, creating five faux fuselages 106. Each faux fuselage 106 contains 4, 5 or 6 seats per row which is a traditional number of seats per row and results in a size that approximates a conventional passenger jet. In the exemplary configuration illustrated in FIG. 2a/2b, the aircraft designer one synthetic window may be installed at one or both ends of each row in each faux fuselage. (See also, FIG. 4). However, one of ordinary skill in the art would recognize that any number, size, shape, type, location and configuration of synthetic windows may be used.

In another exemplary embodiment, in a spacecraft context, a synthetic window may be placed in all or part of an interior or an exterior bulkhead. In the weightlessness of space, one may become disoriented, claustrophobic or suffer from motion sickness. Particularly with passenger spacecraft, it is desirable to provide passengers with a visual orientation reference such as the earth, the moon or the stars. As such, a synthetic window as further disclosed herein may provide an efficient means to provide a number of passengers with synthetic windows without penetrating the pressure bulkhead 102 with actual windows. It should be noted that the terms “exterior bulkhead”, “skin” and “pressure bulkhead” may be synonymous when used in the context of some types of vehicles such as submarines, spacecraft and aircraft. Synthetic windows 50 may be provided individually to small groups of passengers that simulates a traditional aircraft. Alternatively, an entire bulkhead (102,104), or portion thereof, may be presented as a synthetic window as may be desirable. It should be kept in mind that a bulked in a space context may be a wall, an over head or a floor in a terrestrial context.

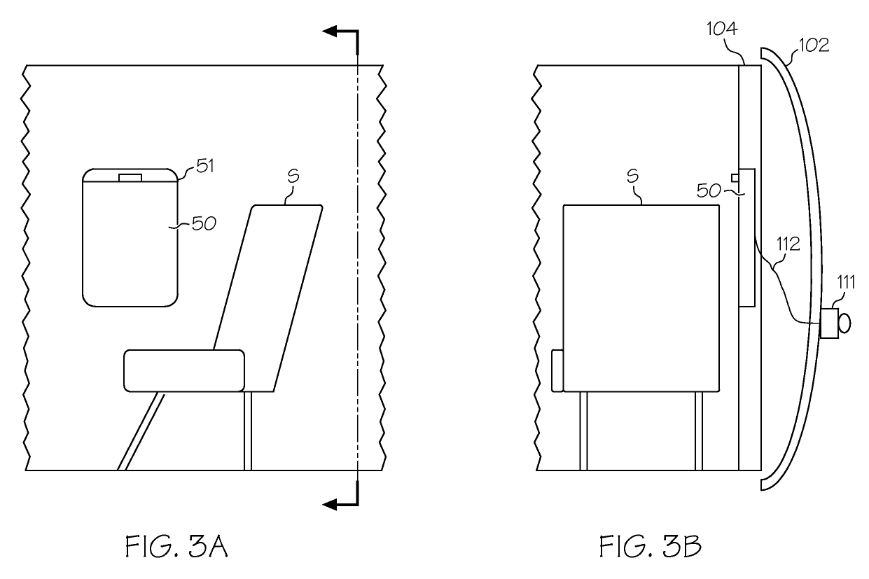

FIG. 3 illustrates a non-limiting exemplary embodiment wherein a synthetic window of an aircraft is located next to a seat (S). The skilled artisan, foe psychological reasons, may choose to exactly recreate the size and shape of a conventional window using a video display device 50. Commonly, an aircraft window is double paned with an external pane set within the outer skin of the aircraft 102 and an internal pane (not shown) that is proximate to the passenger (i.e. the user). This same arrangement may be replicated by insetting the video display device 50 into an interior bulkhead 104, thereby replicating the typical exterior window pane, which is then protected by an inside window pane (not shown). To further the replication, a conventional window shade 51 may be included.

Because a high degree of realism may be desired to satisfy the psychological and/or physical needs of passengers, the bulkhead may need to flushly surround the marginal edges of the viewing screen of the visual display device 50 to more completely mask its true nature and more easily perfect the illusion of a window. In some embodiments, the image to be displayed on the video display device 50 may be a real time view that a passenger sitting in the seat (S) may otherwise see through an actual window penetrating the aircraft's skin or pressure bulkhead 102. It should be noted that the terms “exterior bulkhead”, “skin” and “pressure bulkhead” may be synonymous when used in the context of some types of vehicles such as submarines, spacecraft and aircraft.

The view to be displayed may be captured by a video capture device 111 mounted externally to the pressure bulkhead 102 of the aircraft using methods known in the art. The captured image may be fed directly into the video display device 50 comprising the synthetic window through cable 112. One of ordinary skill in the art would also recognize other alternative views may be utilized. Such alternatives may include real time views from other vantage points within or exterior to the vehicle. In other embodiments, the view may be pre-recorded and when combined with other digital video technology may be designed to move the image in simulation of the aircraft's maneuvers. For example, inertial detectors (not shown) (e.g. accelerometers, gyroscopes, etc) may detect a banking turn. In response to the detected attitude change, a video processor 105 (see, FIG. 4) may query a data file that, when transmitted to the synthetic window 50, may cause the displayed image to change to include more sky, more terrain or change the relative position of the sun, moon or stars in the simulated view.

The video capture device 111 may be any video camera known in the art suitable for use in an environment normally found external to the vehicle upon which it is installed. Such exemplary environments may include underwater environments, vacuum environments and environments with high wind speeds. The video capture device 111 may be an analog video camera or a digital video camera. The video capture device 111 may be located anywhere on the aircraft including directly behind the video display device 50 and outside the skin 102 of the aircraft. The video capture device 111 may use any type of lens as may be needed or desired to reproduce the desired view or achieve the desired quality of the view. If the desired views are pre-recorded, a video capture device 111 is not necessary. Further, the video capture device 111 may be mounted such that it may pan or move in order to produce the view desired, using technology that is well known in the art.

Similarly, the video display device 50 may be any type of suitable video display. Non-limiting examples of suitable video display devices may include a liquid crystal display (LCD), a plasma array screen, a television, a computer monitor or any other video display devices that may be developed in the future and be suitable for the purpose. The video display device 50 may be a flat screen or it may have a contoured form or surface that best reproduces the view or achieves the quality of the view desired.

For video capture devices 111 and video display devices 50 that are electronically compatible, analog-to-digital conversion or other signal processing may not be needed. In such cases, a direct cable connection 112 between the output of the video capture device 111 and the input of the video display device 50 may be used to transfer a signal of the captured view from the video camera 111 to the video display device 50. Leading the cable 112 through the pressure bulkhead 102 may be a much simpler task than installing a window in the pressure bulkhead 102. Alternatively, the connection may be wireless, using such non-limiting exemplary wireless protocols as Wi-fi, Zigbee, Bluetooth or any other suitable standard in existence now or in the future. If signal processing is required, then the video signals from the video capture device 111 may processed and distributed to the video display device 50 through a suitable video processor/router 105 (see, FIG. 4). Alternatively, any needed signal processing may be performed locally within the video display device 50.

Processor 105 may also contain computer readable instructions that, when executed, may perform casualty recovery or redundancy actions. Such actions may include automatically switching in a redundant or alternate video capture device 111 for a video capture device 111 that may fail. Processor 105 may include a central processing unit, an embedded processor, a specialized processor (e.g. digital signal processor), or any other electronic element responsible for interpretation and execution of instructions, performance of calculations and/or execution of voice recognition protocols. Processor 105 may communicate with, control and/or work in concert with other functional components, including the video capture device 111, the video display device 50, and/or any digital router. Communication between components may be in the form of multiple parallel paths, a single serial path, or any other communication scheme via cable runs or data busses as may be found to be useful.

FIG. 4 illustrates another exemplary embodiment of the subject matter disclosed herein. The number of interior bulkheads 104, exterior bulkheads 102, video display devices 50, video capture devices 111 and video processor and/or routers 105 depicted are merely exemplary and may vary depending on the size of the vehicle, type of vehicle and design choices made by the aircraft designer. The mix of components disclosed herein has been limited solely for the sake of clarity. Each faux fuselage in this non-limiting example is depicted as being identical merely for simplicity of explanation.

In this exemplary embodiment, a portion of a simplified aircraft fuselage 100 comprises four video capture devices 111, two exterior bulkheads 102, two interior bulkheads 104, 12 seats (S) arranged in two rows and six columns making up three faux fuselages (106-1, 106-2, 106-3). However, there may be any number of rows, seats and bulkheads in any configuration and not necessarily arranged in rows and columns.

In this non-limiting example, each row in a faux fuselage 106 happens to have a port synthetic window 50 and a starboard synthetic window using a video display device 50. To identify the locations of the synthetic windows more clearly, each video display device 50 is further identified by a code which includes a letter S for the starboard side of its faux fuselage 104 or exterior bulkhead 102 or P for the port side of its faux fuselage 104 or exterior bulkhead 102 followed by a number for the row, and followed by a number for a faux fuselage 106. For example, the identifying code for the most forward synthetic window 50 to the port side of the aircraft would be P11.

Each row of seats (S) across a faux fuselage may include a synthetic window (e.g, P11 and S11) comprising a properly affixed video display 50 at each end of the row with a passenger access aisle between the seats (S). As such, there are six video display devices (50) in the first row of fuselage 100 including the six synthetic windows (P11-P13 and S11-S13). Each of the port synthetic windows (P11-P13) in the first row of fuselage 100 may be connected to receive the video signals transmitted by the port side video capture device P1 and each of the port synthetic windows (S11-S13) in the first row may be connected to receive the video signals transmitted by the port side video capture device S1. A similar arrangement may be mimicked for the second row with synthetic windows P21-P23 and S21-S23 displaying the view captured by the video capture devices P2 and S2, respectively. One of ordinary skill in the art would recognize after reading this disclosure that each row of seats may observe views captured by a port and starboard video capture device (50) affixed to capture the view that normally would have been seen through an actual window in that row, or the closest achievable view to it. However, a particular view display device 50 may display a view from any other video capture device 111 as well. Similarly, all video display devices 50 may display the same view from a single video capture device 111.

As discussed above, should the video capture devices 111 be electronically compatible with the video display devices 50 each video capture device (e.g. P1) may be directly coupled to each video display device 50 of its synthetic windows (e.g. P1X). However, in alternative arrangements, the output of several video capture devices (e.g. P1, P2, S1, S2) may be received, processed and rerouted to selected video display devices (P11-P13; S11-S13) using a video processor and/or a digital router 105. This routing may be accomplished over a wired network or may be accomplished wirelessly. Video processing and digital routing are well known in the art but are beyond the scope of this disclosure.

Any of the instructions for carrying out the methods described herein may be read and/or executed from a computer readable medium. A computer readable medium may comprise any electronic memory device, memory disk or electronic signal capable of recording and/or conveying the instructions to a computing device. Non-limiting examples of a computer readable medium include volatile memory devices such as random access memory and computer processors and non-volatile memory devices such as optical disks, flash memory, magnetic disks and read only memory.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1) A synthetic window system, comprising:
a first interior bulkhead integral to a vehicle;
a first video display device demountably affixed within a cavity of the first interior bulkhead such that all marginal edge portions of a viewing screen of the first video display device are flushly surrounded by the first interior bulkhead, the viewing screen of the first video display device being viewable by the user; and
a first video capture device providing a first video signal to the first video display device, the first video capture device capturing a view from a first vantage point located outside of the vehicle and in proximity to the first video display device for viewing on the viewing screen of the first video display device via the first video signal.

2) The synthetic window system of claim 1, further comprising:
a second interior bulkhead integral to the vehicle and within viewing range of the user simultaneously with the first viewing screen of the first video display device;
a second video display device demountably affixed within a cavity of the second bulkhead such that all marginal edge portions of a viewing screen of the second video device are flushly surrounded by the second bulkhead, the viewing screen of the second viewing device also being viewable by the user; and
a second video capture device providing a second video signal to the second display device, the second video capture device capturing a second view from a second vantage point located outside of the vehicle and in proximity to the second video display device for viewing on the viewing screen of the second video display via the second video signal.

3) The synthetic window system of claim 1, further comprising:
an exterior bulkhead of the vehicle within viewing range of the user simultaneously with the first video display device; and
a second video display device demountably affixed upon the inside of the exterior bulkhead such that all marginal edge portions of a viewing screen of the second video device are flushly surrounded by the second bulkhead, the viewing screen of the second video display device also being viewable by the user;
a second video capture device providing a second video signal to the second video display device, the second video capture device capturing a second view from a vantage point located outside of the vehicle and in proximity to the second display device for viewing on the viewing screen of the second video display via the second video signal.

4) The synthetic window system of claim 1, wherein the interior bulkhead is any of a floor, a ceiling, a deck, an overhead and a wall.

5) The synthetic window system of claim 3, wherein the exterior bulkhead is any of a floor, a ceiling, a deck, an overhead, and a wall.

6) The synthetic window system of claim 1, further comprising a video router, the video router receiving the first video signal from the first video capture device and transmitting the first video signal to the first viewing device.

7) The synthetic window system of claim 2, further comprising a video router, the video router receiving the first video signal from the first video capture device and receiving the second video signal from the second video capture device and transmitting the first video signal to the first viewing device and the second video signal to the second video device.

8) The synthetic window system of claim 1, wherein the vehicle is any of a submarine, an airplane, a spacecraft, a submersible habitat or an extraterrestrial habitat.

9) The synthetic window system of claim 2, wherein the first vantage point is a point that is directly behind the first viewing device and located on the exterior side of an exterior bulkhead of the vehicle and the second vantage point is a point that is directly behind the second viewing device and located on the exterior side of another exterior bulkhead of the vehicle.

10) A viewing apparatus comprising:
means for detecting a first view from a first vantage point of a vehicle that is external to the skin of the vehicle; and
means for rendering the first view to a user, the means for rendering the first view being embedded within a first interior bulkhead of the vehicle, wherein the first vantage point is located behind the means for rendering the first view.

11) The viewing apparatus of claim 10, further comprising:
a means for detecting a second view from a second vantage point of the vehicle that is external to the skin of the vehicle; and
a means for rendering the second view to the user, the means for rendering the second view being embedded within a second interior bulkhead of the vehicle, wherein the second vantage point is located behind the means for rendering the second view.

12) The viewing apparatus of claim 11, further comprising:
a computing device programmed to:
receive a first electronic signal from the means for detecting the first view corresponding to the first view;
receive a second electronic signal from the means for detecting the first view corresponding to the second view,
process the first electronic signal and the second electronic signal,
render the first view to the means for rendering the first view based at least in part on the first processed electronic signal, and
render the second view to the means for rendering the second view based at least in part on the second processed electronic signal.

13) The viewing apparatus of claim 12, wherein the means for detecting the first view is one of an analog video camera or a digital video camera.

14) The viewing apparatus of claim 10, wherein the skin of the vehicle is a pressure containment bulkhead.

15) The viewing apparatus of claim 10, wherein the first interior bulkhead is a non-structural partition.

16) The viewing apparatus of claim 12, wherein the computing device is a digital router.

17) The viewing apparatus of claim 12, wherein the computing device comprises an analog to digital video signal converter.

18) The viewing apparatus of claim 10, wherein the means for rendering the first view is one of a liquid crystal display, plasma display panel, a television and a video monitor.

19) The viewing apparatus of claim 12, wherein the computing device communicates with the means for detecting the first view and with the means for rendering the first view wirelessly.

20) A vehicle, comprising:
a vehicle body;
an interior bulkhead within the vehicle body;
a plurality of video display devices each demountably affixed within a cavity of the interior bulkhead, each video display device comprising a viewing screen visible to at least one user and flushly surrounded by the interior bulkhead;
a plurality of video capture devices, each video capture device affixed to a vantage point exterior to the vehicle body and in communication with a corresponding video display device of the plurality of video display devices, wherein each vantage point of the plurality of video capture devices is behind the video display device of the plurality of video display devices corresponding to the video capture device affixed thereto.
